(19) United States
(12) Patent Application Publication
(10) Pub. No.: US 2026/0066198 A1
(43) Pub. Date: Mar. 5, 2026

(54) LOW AND MEDIUM VOLTAGE ELECTRICAL POLE

(71) Applicant: ABB S.p.A, Milano (IT)

(72) Inventors: James Mannekutla, Västerås (SE); Julien Rault, Bern (CH); Johan Nohlert, Västerås (SE); Gabriel Lantz, Zürich (CH); Mrunal Parekh, Åkersberga (SE); Martin Neugebauer, Zürich (CH); Ilario Triscari, Västerås (SE); Oscar Taiocchi, Bergamo (IT); Alessio Bergamini, Gazzaniga (BG) (IT); Nicola Bresciani, Bergamo (IT); Luca Gritti, Alzano Lombardo (BG) (IT)

(21) Appl. No.: 19/303,592

(22) Filed: Aug. 19, 2025

(30) Foreign Application Priority Data
Aug. 30, 2024 (EP) 24197559.8

(51) Int. Cl. H01H 33/08; H01H 1/58; H01H 9/32; H01H 31/28; H01H 33/42

(52) U.S. Cl. CPC H01H 33/08; H01H 1/5833; H01H 9/32; H01H 31/283; H01H 33/42

(57) ABSTRACT

A low and/or medium voltage electrical pole which comprises a fixed contact and a movable contact with means for moving the movable contact along a longitudinal axis between open and closed positions. The electrical pole also comprises an insulating assembly comprising a first barrier and a second barrier. The first barrier has first and second insulating walls separated from each other and the second barrier has a third insulating wall. The first and second barriers are positioned around an axis which is substantially perpendicular to said longitudinal axis. At least one of said first and second barriers is movable around said transversal axis between a first position and a second position. When the movable contact is in the closed position, the first and second barriers are in said first position and when the movable contact is in the open position, the first and second barriers are in the second position.

### CROSS REFERENCE TO RELATED APPLICATIONS

The present application claims priority to European Patent Application No. 24197559.8 filed on Aug. 30, 2024, and titled “LOW AND MEDIUM VOLTAGE ELECTRICAL POLE”, which is hereby incorporated by reference in its entirety.

### TECHNICAL FIELD

The present disclosure relates to the field of electrical systems, such as electric grids, switchboards, and the like. More particularly, the present disclosure relates to a switching apparatus, such as, for example, circuit breakers, disconnectors, contactors for low- or medium-voltage electrical systems.

### BACKGROUND

For the purposes of the present disclosure, the term Low Voltage is intended to designate electrical systems operating at voltage levels up to 1 kV AC and 1.5 kV DC, while the term Medium Voltage is intended to designate electrical systems operating at voltage levels higher than 1 kV AC and 1.5 kV DC up to some tens of kV, for example up to 72 kV AC and 100 kV DC.

As it is known, an electrical system may include several switching apparatuses configured in such a way to allow a selective disconnection of electrical sections, for example when a fault event occurs.

Many switching apparatuses of the state of the art are of electromechanical type.

In general, these switching apparatuses have the advantage of ensuring a galvanic isolation between disconnected electric circuits. Additionally, they are relatively cheap to realize at industrial level.

It is known that switching apparatuses, such as for example circuit breakers, disconnectors, contactors, limiters, hereinafter referred to, for reasons of brevity, as switches, comprise one or more electrical poles, associated to each of which there is at least one pair of contacts that can be coupled to and uncoupled from one another. Switches of the known art also comprise control means that cause relative movement of said pairs of contacts so that they can assume at least one first, coupling, position (circuit closed) and one second, separation, position (circuit open). The control means comprise, for instance, mechanisms, which terminate, for example, in a shaft operatively connected to said mobile contacts.

In particular, the circuit breakers are usually provided with a system which ensures the nominal current required for the various users, the connection and disconnection of the load, protection against any abnormal conditions (such as overloading and short-circuit) by automatically opening the circuit, and the disconnection of the protected circuit by opening the moving contacts with respect to the fixed contacts (galvanic separation) in order to achieve full isolation of the load with respect to the electric power source.

However, the experience has shown how these apparatuses do not often provide satisfactory interruption ratings, in particular when they have to interrupt DC currents at relatively high voltages (for example 1.5 kV DC or above). In these circumstances, in fact, their opening time can be quite long. Electric arcs, which usually strike between electric contacts under separation, may consequently last for a relatively long time, which is quite dangerous as many electrical components (for example photovoltaic panels and energy storage systems) electrically connected to the electric line can potentially feed an undergoing electric fault.

Furthermore, it has been seen that electric arcs may sometime strike towards other conductive parts or components of the switching apparatus, which may be subject to serious damages since they are not generally designed to bear high electric and thermal stresses.

The above-mentioned inconveniences are even made more critical by the circumstance that, in modern electrical systems, switching apparatuses are often brought to operate to relatively high operating voltages. Electric arcs with a high energy content may thus arise between the electric contacts under separation during the opening maneuvers of a switching apparatus.

Due to the above-mentioned criticalities, currently available switching apparatuses typically comprise a relatively high number of switch poles electrically connected in series when operating at relative high voltages. They are thus rather expensive to manufacture at the industrial level and relatively difficult to install due to their relatively large size.

### BRIEF DESCRIPTION

The main aim of the present disclosure is to provide an electrical pole for low or medium voltage electrical switches, which allows overcoming or mitigating the above-mentioned criticalities.

In particular, the present disclosure aims at providing a low and/or medium voltage electrical pole where the arcing phenomena and the related problems can be easily managed.

More particularly, an object of the present disclosure is to provide a low or medium voltage electrical pole ensuring performant interruption ratings in case of electric faults, especially in presence of short-circuit currents. Additionally, it should be capable of interrupting low currents or critical currents.

As a further object, the present disclosure aims at providing a low and/or medium voltage electrical pole having a compact structure and easy to install on the field.

Still another object of the present disclosure is to provide a low or medium voltage electrical pole, which can be easily manufactured at industrial level, at competitive costs relative to the solutions of the state of the art.

In a further aspect, the present disclosure also relates to a low or medium voltage switching apparatus which comprises at least a low and/or medium voltage electrical pole as described herein and at least a further low and/or medium voltage electrical pole.

In particular, it is an object of the present disclosure to provide a low or medium voltage switching apparatus which comprises at least a low or medium voltage electrical pole as described herein and at least a further low and/or medium voltage electrical pole of conventional type, such as an electrical pole having current limiting capabilities, electrically connected in series between them.

In order to fulfill these aims and objects, the present disclosure provides a low or medium voltage electrical pole, according to the following claims.

In a general definition of the disclosure, a low or medium voltage electrical pole as presently disclosed comprises at least a fixed contact and at least a movable contact which can be coupled to/uncoupled from each other between a closed position in which they are in contact with each other and an open position in which they are separated from each other by an opening gap. The electrical pole of the present disclosure further comprises first actuating means for substantially linearly moving said movable contact along a first, longitudinal, axis between said open and closed positions.

The electrical pole of the present disclosure is characterized in that it comprises an electrical insulating assembly which comprises at least a first barrier element which is provided with at least a first insulating wall.

Said first barrier element is rotationally movable around a second, transversal, axis which is perpendicular to said first, longitudinal, axis between a first operative position, in which said first insulating wall is positioned on a side of said opening gap, and a second operative position.

In the electrical pole of the present disclosure, when said fixed and movable contact are in the closed position said first barrier element is in said first operative position and when the fixed and movable contact are in the open position said first barrier element is in a second operative position with at least a portion of said first barrier elements interposed between said fixed and movable contact in said opening gap.

In embodiments of the electrical pole of the present disclosure, the electrical insulating assembly comprises a first barrier element and a second barrier element. The first barrier element is provided with at least an insulating wall, and in some embodiments with a first and a second insulating wall which are separated from each other by an intermediate gap and the second barrier element is provided with at least a third insulating wall.

Said first and second barrier element are coaxially positioned with respect to each other around said second, transversal, axis, which is substantially perpendicular to said first, longitudinal, axis. At least one of said first and second barrier element is rotationally movable around said second, transversal, axis between a first operative position and a second operative position,

In said first operative position, the first and second insulating walls are spaced apart from said third insulating wall on opposite sides of said opening gap and in said second operative position the third insulating wall is at least partially inserted into the intermediate gap between said first and second insulating wall.

In the electrical pole of the present disclosure, when said fixed and movable contact are in the closed position said first and second barrier element are in said first operative position and when the fixed and movable contact are in the open position said first and second barrier elements are in said second operative position with at least a portion of said first and/or second barrier element interposed between said fixed and movable contact is said opening gap.

For the purposes of the present disclosure, the features “spaced apart on opposite sides of said opening gap” referred to the respective position of the first and second barrier elements, is meant to designate situations where the first and second barrier elements do not occupy the volume of the opening gap between the fixed and movable contact, for example when one of the barrier elements is on the left hand side of the first, longitudinal, axis of movement of the movable contact and the other barrier element is on the right hand side of the first, longitudinal, axis of movement of the movable contact with respect to a front direction of view of the electrical pole perpendicular to said first, longitudinal, axis.

In this way, as better described hereinafter, in the electrical pole of the present disclosure, the design and the positioning of the electrical insulating assembly—and in particular, the design and functioning principles of first and second barrier elements—provides an efficient system for controlling the arcing phenomena during opening/closing operation of the switching apparatus.

In the following detailed description, the present disclosure will be described with reference to an electrical pole for a low voltage switch, such as a circuit breaker, which is provided with an electrical insulating assembly equipped with the relevant barrier elements but, in general, it can be applied to any type of low or medium voltage switching apparatuses depending on the applications and operational needs.

In practice, in the first operative position the first and second barrier elements are capable of assuming a first relative position, in which the first and second insulating walls of said first barrier element and the third insulating wall of said second barrier element are at a distance from each other and allow passage of the movable contact so that said movable contact can couple with or decouple from said fixed contact.

Then, in the second operative position, the first and second barrier elements are capable of assuming a second relative position, in which the third insulating wall is at least partially inserted into the intermediate gap between said first and second insulating wall and at least a portion of the first and/or second barrier element is interposed between movable and fixed contacts and forms a dielectric barrier in the opening gap between said movable contact and said fixed contact.

Moreover, due to the design of the barriers, the electrical arc is squeezed along a tortuous path and can be efficiently controlled even in case of relatively high energy release like, for example, under short circuit conditions.

As explained in the following detailed description of some embodiments—in general embodiments of the switching apparatus of the present disclosure, the first and/or the second barrier element rotationally moves from the first operative position to the second operative position when the movable contact moves from the closed position to the open position. The opening gaps between the contact is therefore closed and the insertion of the third insulating wall of the second barrier element into the intermediate gap between the first and second insulating walls of the second barrier element creating a tortuous path and “squeezing” the electrical arc.

Conversely, when the movable contact moves from the open position to the closed position, the first and/or second barrier element rotationally moves from the second operative position to the first operative position, thereby freeing the opening gap and allowing passage of the movable contact so that it can couple with the fixed contact and the contact system can reach the closed configuration.

According to a general definition of the present disclosure, in the presently disclosed electrical pole, in the closed conditions of the contacts system, the first and second electrical barriers are retracted in the direction of the movable contact, while in the open conditions of the contacts system at least a portion of the first and/or second barrier element is interposed between the fixed and movable contacts in said opening gap.

In other words, as a general principle, the second, transversal, axis onto which is positioned the center of rotation of the at least one of said first and second barrier element is located on the opposite side of the opening gap with respect to the fixed contact. In this way, the moving elements of the pole are concentrated in the same region of the pole (namely the volume where the moving contact and the related actuating system are located), with consequent advantages in terms of compact structure, simplicity of construction, possible synergies between the various actuating systems.

According to embodiments of the low and/or medium voltage electrical pole of the present disclosure, the system may be conveniently provided with second actuating means configured to move the first and/or second barrier element between said first operative position and said second operative position.

Furthermore, the second actuating means of the barrier element(s) may be conveniently synchronized with the first actuating means of the movable contact so that the above-described coordinated movement of the barrier element(s) with respect to the movable contact movement can be achieved.

In practice, in embodiments of the presently disclosed low and/or medium voltage electrical pole, the second actuating means may be operatively connected with the first actuating means of said movable contact. In this way, the movement of the barrier element(s) may by driven by the first actuating means of the movable contact and a proper coordination between the movement of the barrier(s) and of the movable contact can be guaranteed.

The kinematic link between the barrier element(s) and the first actuating means of the movable contact can be designed according to the operational needs and applications. Detailed examples of a possible design of the connection between first and second actuating means will be given further below.

According to embodiments of the low and/or medium voltage electrical pole of the present disclosure, the first barrier element is rotationally movable around said second, transversal, axis between said first operative position and said second operative position, while the second barrier element is fixed with respect to said fixed contact.

In these embodiments of the presently disclosed electrical pole, the second barrier element remain fixed on a side of the opening gap.

During the contact opening operation, the second barrier element rotates from the first operative position—in which it is spaced apart from the first barrier element on an opposite side of the opening gap—to the second operative position in which a first portion thereof is positioned around the second barrier element (namely the second barrier element is at least partially inserted into the intermediate gap between the first and second insulating walls), while a second portion of the first barrier element is interposed between the fixed and movable contacts in correspondence of the opening gap.

During the contact closing operation, the second barrier element rotates in the opposite direction from the second operative position to the first operative position, freeing the opening gap and allowing the passage of the movable contact.

In design embodiments of the low and/or medium voltage electrical pole of the present disclosure, the first barrier element may be formed as a single body comprising the first and second insulating walls. In practice, the first insulating wall may be connected to the second insulating wall along a first side substantially parallel to the second, transversal, axis. The second sides—opposite to said first side—of the first and second insulating walls form a slot which is also substantially parallel to said second, transversal, axis, and which allows the entry of the third insulating wall into the intermediate gap between the first and second insulating walls.

In embodiments of the presently disclosed low and/or medium voltage electrical pole, the first actuating means of said movable contact may conveniently comprise a rotating actuating disk and a first kinematic link connecting said disk and said movable contact. For the purposes of the present disclosure, the term “disk” is meant to designate a plate of suitable material having, in some embodiments, a substantially circular shape.

The rotating actuating disk may be conveniently operatively connected to the main operating shaft of the switching device in which the electrical pole is positioned, thereby receiving motion from the operating command of the switching device and then transmitting the motion, through the first kinematic link, to the movable contact.

In some embodiments of the electrical pole of this disclosure, said first kinematic link may comprise a lever system—an example of which will be described in detail in the following detailed description—which is capable to transform a rotation movement of said rotating actuating disk in a substantially linear displacement of said moving contact.

From a design standpoint, in some embodiments the rotating actuating disk may rotate around a third, transversal, axis which is substantially parallel to said second, transversal, axis and perpendicular to said first, longitudinal, axis. In practice, according to these embodiments, the rotation of the rotating actuating disk takes place around a rotation center which is offset with respect to the rotation center of the barrier element(s), according to embodiments described in detail hereinafter.

In embodiments of the electrical pole of the present disclosure, the second actuating means—which actuate the movement of the first and/or second barrier element(s)—may, in some embodiments, comprise a rotating actuating plate which is operatively connected to the first actuating means of said movable contact.

In such embodiments, the rotating actuating plate may conveniently rotate around said second, transversal, axis and is operatively connected to said rotating actuating disk through a second kinematic link.

In practice, according to these embodiments, the motion of the rotating actuating plate—and consequently the motion of the first and/or second barrier element(s)—may be actuated by the motion of the first actuating means of the movable contact (for example by the rotating actuating disk of the movable contact), which in turn may be actuated by the main operating shaft of the switching device in which the electrical pole is positioned.

According to embodiments of the low and/or medium voltage electrical pole of the present disclosure, the first barrier element may be supported by and rotates with said rotating actuating plate, the second barrier element remain fixed with respect to said fixed contact, thereby achieving a very simple and compact construction structure.

In a further aspect, the present disclosure also relates to a low or medium voltage switching apparatus which comprises at least a low and/or medium voltage electrical pole as described herein.

In particular, according to embodiments of the presently disclosed switching apparatus, said apparatus may conveniently comprise at least a first low or medium voltage electrical pole as described herein and at least a further low and/or medium voltage electrical pole of conventional type, such as an electrical pole having current limiting capabilities.

In some embodiments, said first electrical pole and said second electrical pole are electrically connected in series, so that effective management of installation operating with relatively high voltage/current values may be achieved.

According to further embodiments of the presently disclosed switching apparatus, said first electrical pole may conveniently comprise a further contact pair with a further fixed contact and a further movable contact which can be coupled to or uncoupled from each other between a closed position in which they are in contact with each other and an open position in which they are separated from each other. In particular, said further contact pair is connected in series with one of said fixed contact and movable contact, so as to combine within the same pole a combination of different interruption technologies.

### BRIEF DESCRIPTION OF DRAWINGS

Further features and advantages of the present disclosure will be more apparent from the description of various embodiments of the present disclosure, shown by way of examples in the accompanying drawings.

FIG. 1 is a perspective view of an embodiment of a low and/or medium voltage electrical pole, according to the present disclosure, in a first operative position (contacts closed).

FIG. 2 is a schematic side view of the embodiment of the low and/or medium voltage electrical pole represented in FIG. 1.

FIG. 3 is a perspective view of an embodiment of a low and/or medium voltage electrical pole, according to the present disclosure, in a first intermediate position.

FIG. 4 is a schematic side view of the embodiment of the low and/or medium voltage electrical pole represented in FIG. 3.

FIG. 5 is a perspective view of an embodiment of a low and/or medium voltage electrical pole, according to the present disclosure, in a second intermediate position.

FIG. 6 is a schematic side view of the embodiment of the low and/or medium voltage electrical pole represented in FIG. 5.

FIG. 7 is a perspective view of an embodiment of a low and/or medium voltage electrical pole, according to the present disclosure, in a second operative position (contacts open);

FIG. 8 is a schematic side view of the embodiment of the low and/or medium voltage electrical pole represented in FIG. 7.

FIG. 9 is a schematic side view of an embodiment of the contact assembly in a low and/or medium voltage electrical pole, according to the present disclosure, in the open contacts condition.

FIG. 10 is a schematic side view of an embodiment of the contact assembly in a low and/or medium voltage electrical pole, according to the present disclosure, in the closed contacts condition.

FIG. 11 is a schematic side view of an embodiment of the electrical insulation assembly in a low and/or medium voltage electrical pole, according to the present disclosure, in the open contacts condition.

FIG. 12 is a schematic side view of an embodiment of the electrical insulation assembly in a low and/or medium voltage electrical pole, according to the present disclosure, in the closed contacts condition.

FIG. 13 is a schematic side view of an embodiment of the contact assembly and electrical insulation assembly in a low and/or medium voltage electrical pole, according to the present disclosure, in the open contacts condition.

FIG. 14 is a schematic side view of an embodiment of the contact assembly and electrical insulation assembly in a low and/or medium voltage electrical pole, according to the present disclosure, in the closed contacts condition.

FIG. 15 is a perspective view of a first embodiment of a switching apparatus, according to the present disclosure.

FIG. 16 is a perspective view of a second embodiment of a switching apparatus, according to the present disclosure.

### DETAILED DESCRIPTION

With reference to the attached figures, the present disclosure—in its more general definition-relates to an electrical pole for low and/or medium voltage applications designated in the various embodiments with the reference numeral 1.

The electrical pole 1 comprises at least a fixed contact 2 and at least a movable contact 3 which can be coupled to/uncoupled from each other between a closed position in which they are in contact with each other and an open position in which they are separated from each other by an opening gap 10.

The electrical pole 1 further comprises first actuating means 4 configured to move the movable contact 3 between said open and closed positions, with a substantially linear displacement along a first, longitudinal, axis 100 between said open and closed positions.

A characterizing feature of the electrical pole 1 of the present disclosure is given by the fact that it comprises an electrical insulating assembly 5 comprising a first barrier element 51 and a second barrier element 52, at least one of said barrier elements 51, 52 being rotationally movable as better described herein. In particular, the first and second barrier elements 51, 52 are coaxially positioned with respect to each other around a second, transversal, axis 200 which is substantially perpendicular to said first, longitudinal, axis 100.

In practice, the second, transversal, axis 200 onto which is positioned the center of rotation 201 of the at least one of said first 51 and second 52 barrier element is located on the opposite side of the opening gap 10 with respect to the fixed contact 2. Put in other terms, and having as a reference the first, longitudinal, axis 100, the opening gap 10 is positioned between the fixed contact 2 and the center of rotation 201 of the at least one of said first 51 and second 52 barrier element.

In general, the first barrier element 51 is provided with at least a first 511 and a second 512 insulating walls which are separated from each other by an intermediate gap 55. In turn, the second barrier element 52 is provided with at least a third insulating wall 523.

In the exemplary embodiments of the figures, the first 511, second 512, and third 523 insulating walls—when seen in section—conveniently have an arc-shaped profile centered on the second, transversal, axis 200.

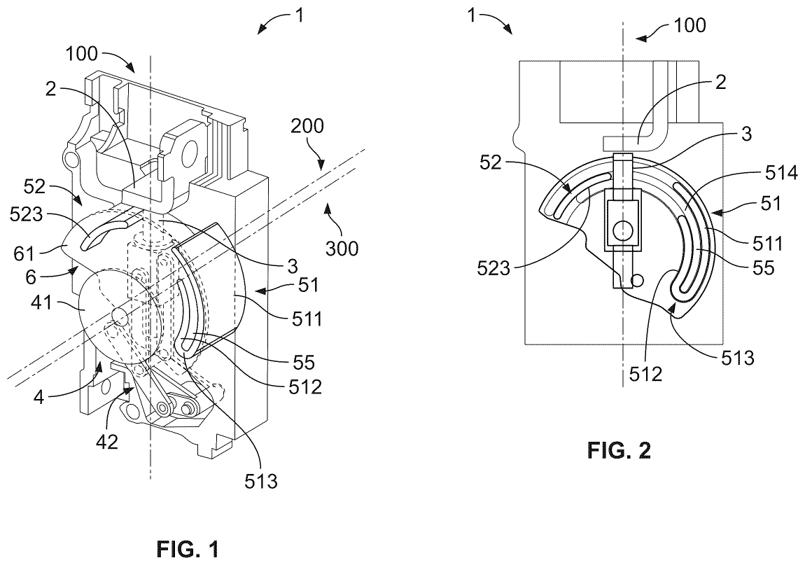

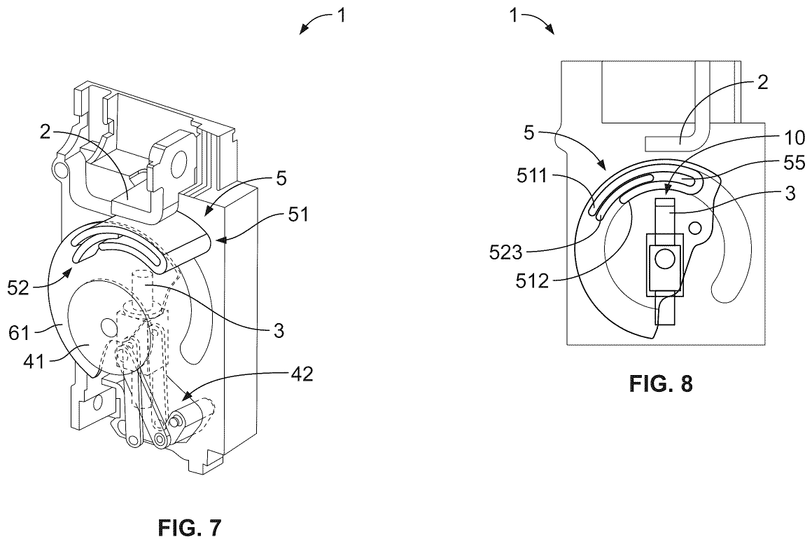

At least one of said first 51 and second 52 barrier elements is rotationally movable around said second, transversal, axis 200 between a first operative position (represented in FIGS. 1, 2, 10, 12 and 14) and a second operative position (represented in FIGS. 7, 8, 9, 11, and 13).

As shown in the attached figures, in said first operative position the first 511 and second 512 insulating walls are spaced apart from the third insulating wall 523 on opposite sides of said opening gap 10.

In practice, in the first operative position, the first 51 and second 52 barrier elements do not occupy the volume of the opening gap 10 between the fixed 2 and movable contact 3, but—with reference to the attached figures—the first 511 and second 512 insulating walls are positioned on the right hand side of the first, longitudinal, axis 100 of movement of the movable contact 3, while the third insulating wall 523 is positioned on the left hand side of said first, longitudinal, axis 100.

In the second operative position, shown in FIGS. 7, 8, 9, 11, and 13, said third insulating wall 523 is at least partially inserted into the intermediate gap 55 between the first 511 and second 512 insulating wall, and at least a portion of first 51 and/or second 52 barrier element is interposed between said fixed 2 and movable 3 contact in the opening gap 10 between them.

In other words, in the closed contacts position of FIGS. 1, 2, 10, 12 and 14, the first 51 and second 52 barrier element are in said first operative position at opposite sides of the opening gap 10, while when the fixed 2 and movable 3 contact are in the open position of FIGS. 7, 8, 9, 11, and 13, the first 51 and second 52 barrier elements are in said second operative position where they are interposed between the fixed 2 and movable 3 contacts and form a dielectric barrier in the opening gap 10 between the contacts 2, 3.

According to the embodiments of the electrical pole 1 shown in the figures, the first barrier element 51 is rotationally movable around said second, transversal, axis 200 between the first operative position and the second operative position, while the second barrier element 52 remains in a fixed position with respect to said fixed contact 2. In the following, the operative functioning of the presently disclosed electrical pole 1 will be described with reference to such solution without limiting the scope of the present disclosure, as the operating principles are applicable also to solutions in which both barrier elements 51 and 52 are movable or in which the first barrier element 51 is fixed and the second barrier element 52 is movable.

With particular reference to FIG. 1-8 the sequence of operation during the opening/closing maneuver can be described as follows.

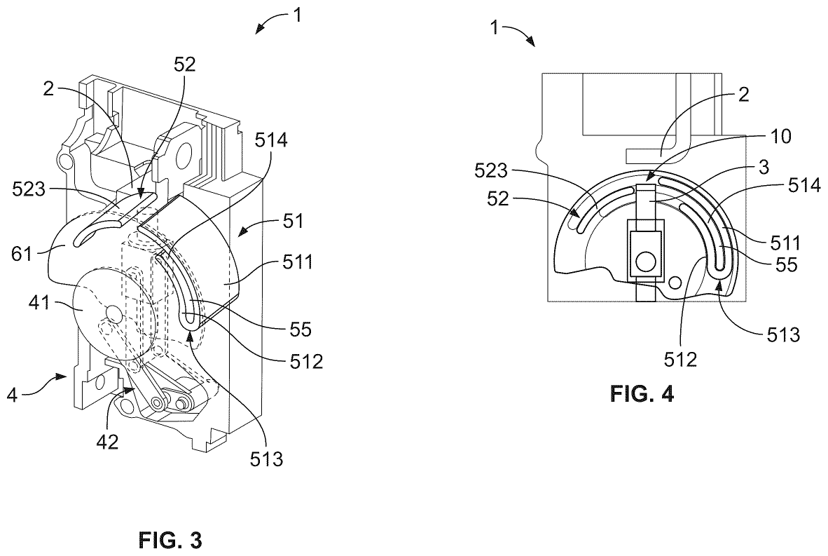

In the contact closed position of FIGS. 1 and 2 (first operative position), the barrier elements 51 and 52 are positioned on opposite sides of the opening gap 10. As soon as the moving contact 3 starts moving (FIGS. 3 and 4), the first barrier element 51 starts moving counterclockwise while the second barrier element 52 remains in its position.

As shown in the attached figures, the first insulating wall 511 is somehow longer than the second insulating wall 512. In a first intermediate position, the first insulating wall 511 can therefore immediately approach the opening gap 10, thereby reducing the volume into which the arc strikes while the second insulating wall 512 does not interfere with the downward movement of the movable contact 3.

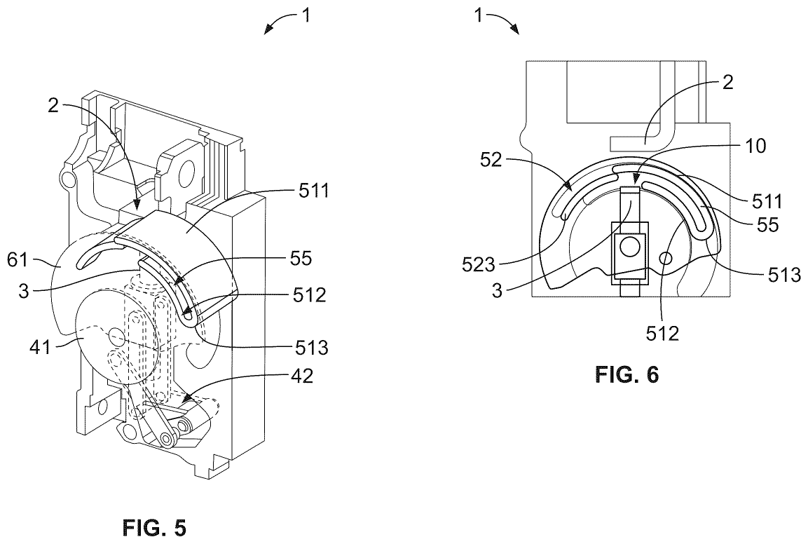

In a second intermediate position represented in FIGS. 5 and 6, the first barrier element 51 has continued the counterclockwise movement, while the movable contact 3 has further moved downward, thereby allowing also the second insulating wall 512 to get closer to the opening gap 10. At the same time, the first insulating wall 511 has reached the extreme portion of the third insulating wall 523, thereby closing the opening gap 10 between the fixed 2 and movable 3 contacts.

In the contact open position of FIGS. 7 and 8 (second operative position), both the movable contact 3 assembly and the electrical insulation assembly 5 have completed their movement. The movable contact 3 is in the open position, while the first barrier element 51 (namely the first 511 and second 512 insulating walls) has completed its rotation and is interposed between the movable 3 and fixed 2 contacts in the opening gap 10, thereby creating a dielectric barrier between them.

At the same time, the third insulating wall 523 of the second barrier element 52 is inserted in the intermediate gap 55 between the first 511 and the second 512 insulating walls of the first barrier element 51. In this way an elongated and tortuous arc path is created around the third insulating wall 523 and inside the intermediate gap 55 of the first barrier element 51, thereby achieving an effective squeezing of the arc.

From a practical design standpoint, the low and/or medium voltage electrical pole 1 of the present disclosure, further comprises second actuating means 6 with the function of moving the first 51 and/or the second 52 barrier element(s) between their first operative position and their second operative position.

In particular, according to some embodiments of the present disclosure, said second actuating means 6 can be operatively connected with the first actuating means 4 of said movable contact 3, so that an effective coordination and synchronization of the movement of the movable contact 3 and of the barrier element(s) 51 and 52 can be easily achieved.

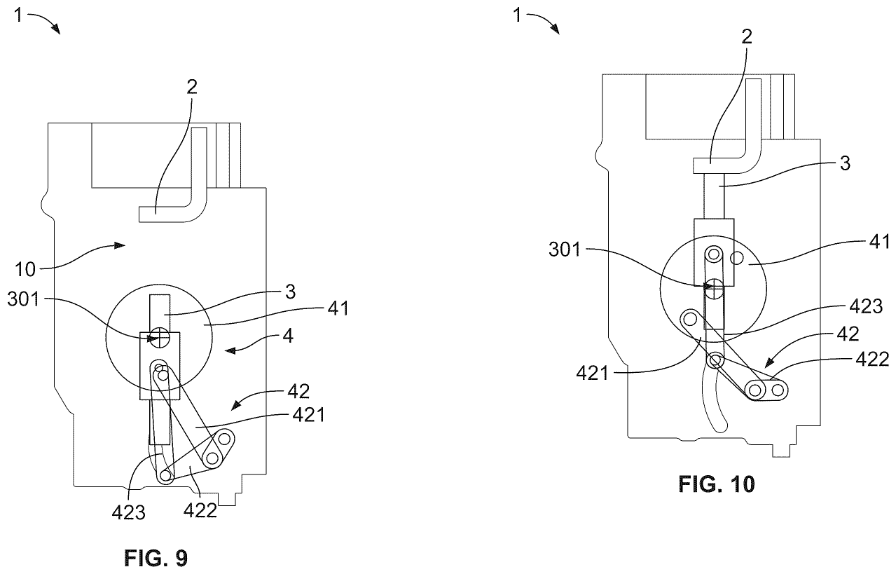

With reference to FIGS. 9 and 10, in exemplary embodiments of the presently disclosed low and/or medium voltage electrical pole 1, the first actuating means 4 of the movable contact 3 conveniently comprise a rotating actuating disk 41 and a first kinematic link 42 which connects the rotating actuating disk 41 and said movable contact 3.

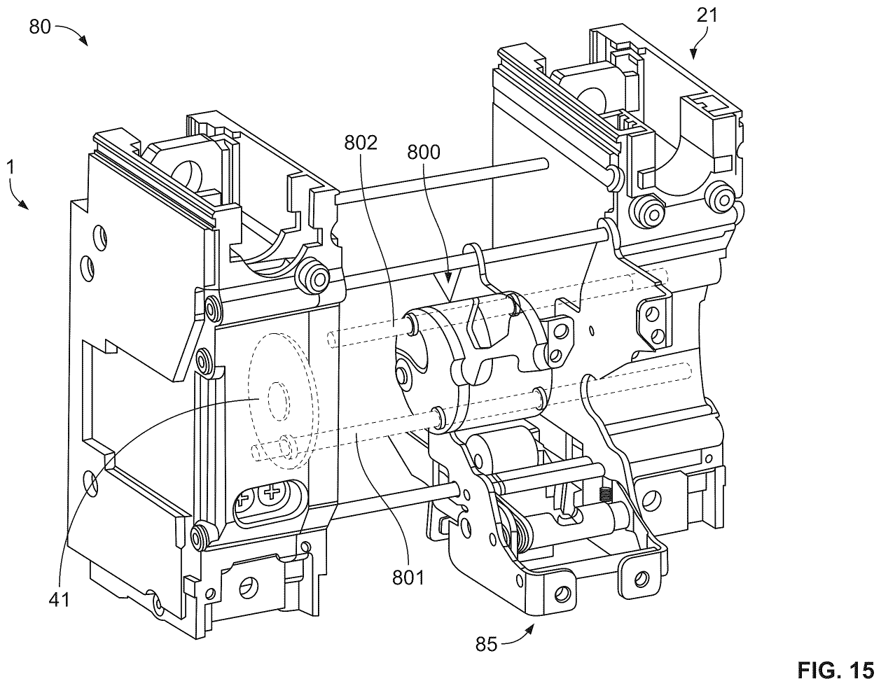

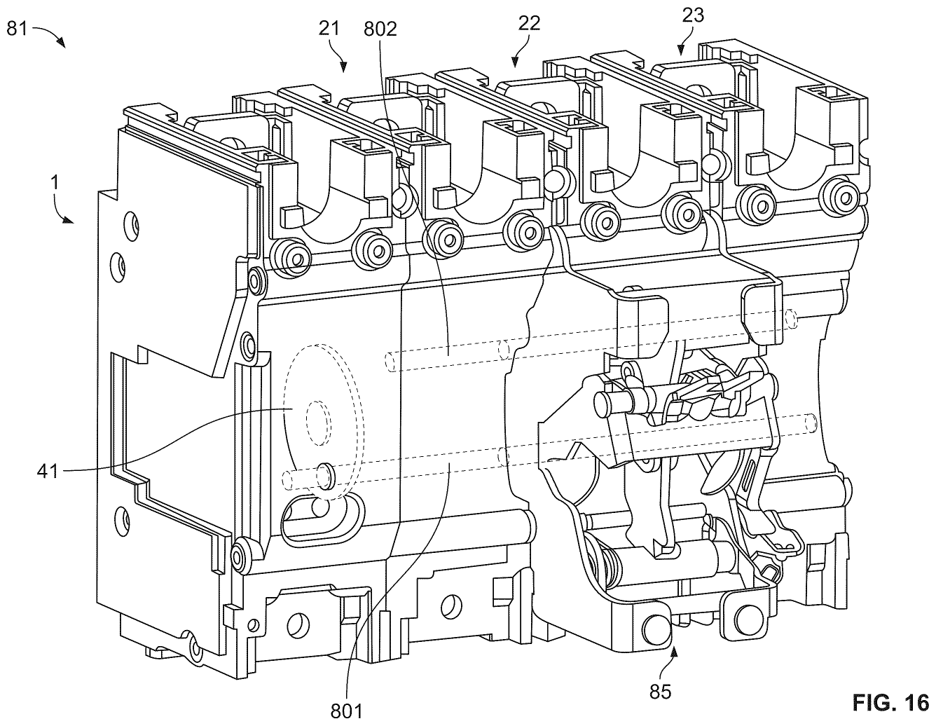

As better described hereinafter and with reference to FIGS. 15 and 16, in some exemplary embodiments of the present disclosure, the rotating actuating disk 41 is conveniently operatively connected to the main operating shaft 800 of the switching device 80, 81 in which the electrical pole 1 is positioned. In this way, the rotating actuating disk 41 is driven in motion by the operating command 85 of the switching device 80, 81 and then transmits the motion, through the first kinematic link 42, to the movable contact 3.

As shown in the attached figures, said first kinematic link 42 can, for example, comprise a lever system which transforms the rotation movement of the rotating actuating disk 41 around a rotation center 301 in a substantially linear displacement of the moving contact 3 along the first, longitudinal, axis 100.

In the examples of the first kinematic link 42 shown in the attached figure, the lever system comprises: a first lever 421 having a first end rotationally hinged on the rotating actuating disk 41; a second lever 422 having a first end rotationally hinged on a fixed point of the electrical pole 1; and a third lever 423 having a first end rotationally hinged on the body of the moving contact 3. A second end of the third lever 423 is rotationally hinged on a second end of the second lever 422, and a second end of the first lever 421 is rotationally hinged on an intermediate point of the second lever 422 which is located between the first and second end of said second lever.

As shown in FIGS. 9 and 10, such articulated lever system allows transforming the rotation movement of the rotating actuating disk 41 in a linear displacement of the moving contact 3 very easily and efficiently, as a clockwise rotation of a few degrees of the rotating actuating disk 41 brings about upward linear movement of the movable contact 3 from the open position of FIG. 9 to the closed position of FIG. 10 (and the other way round in the opening operation). Other solutions are however possible.

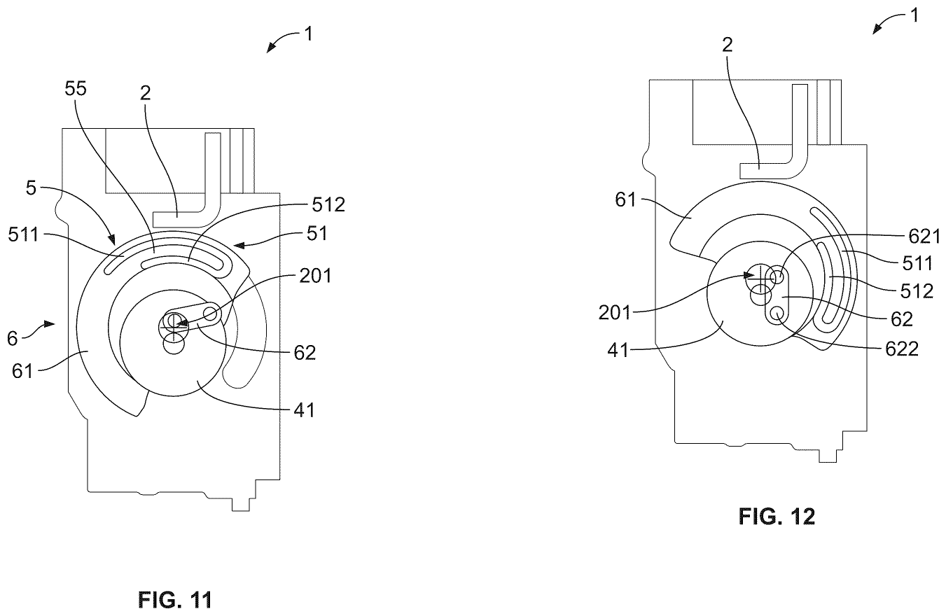

With particular reference to FIGS. 11 and 12, in some exemplary embodiments of the low and/or medium voltage electrical pole of the present disclosure, the second actuating means 6 configured to move the first 51 and/or the second 52 barrier element(s) between their first operative position and their second operative position comprise a rotating actuating plate 61 which is operatively connected to the first actuating means 4 of said movable contact 3. The plate 61 can be, for example, a portion of a disk with substantially circular shape, but different shapes can be used according to the needs.

The rotating actuating plate 61 rotates around a center of rotation 201 which is positioned on the second, transversal, axis 200, said rotating actuating plate 61 being substantially perpendicular to said second, transversal, axis 200.

Moreover, in the embodiments shown, the rotating actuating plate 61 is operatively connected to the rotating actuating disk 41 of the first actuating means 4 of the movable contact 3 through a second kinematic link 62.

In this way, the motion of the rotating actuating plate 61 and of the first barrier element 51 is actuated by the motion of the rotating actuating disk 41 of the first actuating means 4 of the movable contact 3, thereby achieving full coordination of movement between the movable contact 3 and the insulating barrier.

In the examples shown, and with particular reference to FIG. 11-14, the second kinematic link 62 is a connecting rod having a first end 621 rotationally hinged on the rotating actuating disk 41, and a second end 622 rotationally hinged on the rotating actuating plate 61. By properly selecting dimensions and position of the connection rod 62 it is possible to suitably adjust the transmission ratio of the angular displacement between the rotating actuating disk 41 and the rotating actuating plate 61.

Moreover, the centers of rotations 301 and 201 of, respectively, the rotating actuating disk 41 and the rotating actuating plate 61 can be positioned according to the needs. For instance, in the examples shown, the center of rotation 301 of the rotating actuating disk 41 is offset with respect to the center of rotation 201 of the rotating actuating plate 61. In practice, according to this embodiment, the rotating actuating disk 41 rotates around a third, transversal, axis 300 which is substantially parallel to the second, transversal, axis 200 and perpendicular to the first, longitudinal, axis 100.

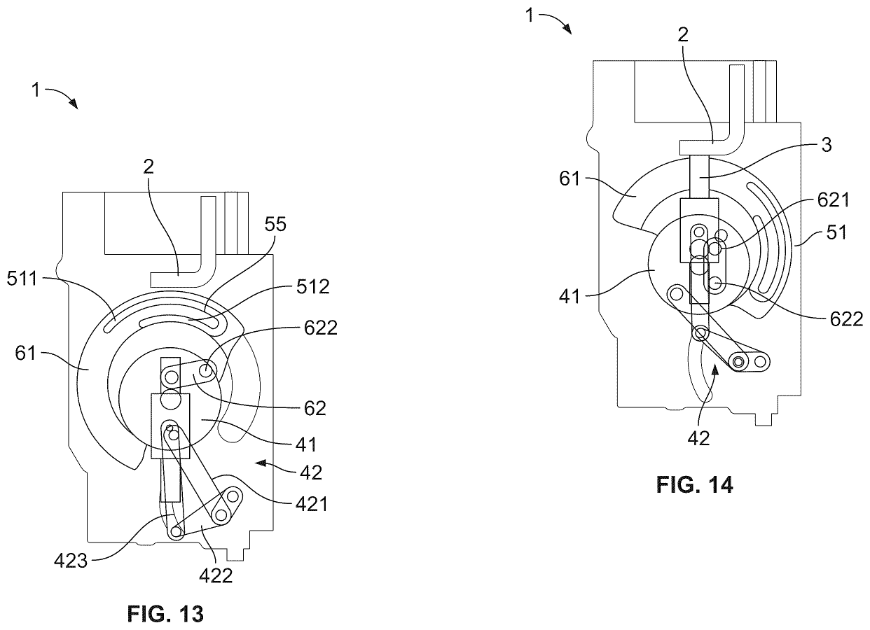

Thus, as shown in particular in FIGS. 13 and 14, a clockwise rotation of a few degrees of the rotating actuating disk 41 brings about an upward linear movement of the movable contact 3 from the open position of FIG. 13 to the closed position of FIG. 14, as well as a clockwise rotation of much higher amplitude of the first barrier element 51 from the second operative position of FIG. 13 to the first operative position of FIG. 14 (and the other way round in the opening operation and the passage from the first operative position to the second operative position of the barrier element 51). Other solutions are however possible.

The electrical pole 1 of the present disclosure, in addition to the improved arc quenching capabilities, can be also provided with constructive features that make it relatively compact and easy to manufacture.

For instance, in some embodiments of the low and/or medium voltage electrical pole of the present disclosure like those shown in the attached figures, the first barrier element 51 can be directly supported by the rotating actuating plate 61 and rotates together with said rotating actuating plate 61, while the second barrier element 52 is kept fixed, thereby reducing the possible number of moving part and simplifying the construction of the pole 1.

According to some embodiments of the presently disclosed low and/or medium voltage electrical pole 1, the first barrier element 51 comprising the first 511 and second 512 insulating walls can be made in a single piece.

In some embodiments, for example in such a case as is described above, the first insulating wall 511 is connected to the second insulating wall 512 along a first side 513 substantially parallel to said second, transversal, axis 200, thereby forming a continuous wall having two parallel branches separated by the intermediate gap 55 which is closed in correspondence of the first side 513.

Along a second side—which is opposite to said first side 513—a slot 514, substantially parallel to the first side 513 and to said second, transversal, axis 200 is formed, and thorough said slot 514 the third insulating wall 523 can be enter into the intermediate gap 55, as previously described.

According to other embodiments (not shown), however, the first and second insulating walls 511, 512 of the first barrier element can be kept spaced one from another along their full length in such a way to define an exhaust passage for hot gases.

In a further aspect, with reference to FIGS. 15 and 16, the present disclosure relates also to a switching apparatus 80, 81 for low and/or medium voltage applications comprising a low and/or medium voltage electrical pole 1, as described herein.

In general, the switching apparatuses commonly used in low or medium voltage applications comprise one or more electrical poles. In the following description, reference will be made to a low voltage switching apparatus, such as a circuit breaker, as represented in the attached figures. The applicability of the present disclosure is however broader and includes in general low and medium voltage switch apparatuses.

The switching apparatus 80, 81 of the present disclosure, comprises at least a first electrical pole 1 according one or more of claims 1-12 and at least a second electrical pole 21, 22, 23, different from said first electrical pole 1.

The arrangement of FIG. 15 is meant to represent the possibility of combining a pole 1—provided with an electrical insulating assembly 5 as described herein—with a conventional pole 21, while the arrangement of FIG. 15 is meant to represent the possibility of combining a pole 1—provided with an electrical insulating assembly 5 as described herein—with an assembly of three conventional poles 21, 22, 23, the present disclosure pole 1 being connected in series with one of said conventional poles 21, 22, 23.

For the purposes of the present disclosure, the term “conventional pole” is meant to designate electrical poles different from the presently claimed electrical pole, namely electrical poles not including a rotating insulating assembly as disclosed herein.

In FIGS. 15 and 16 only the electrical poles 1, 21, 22, 23 and part of the operating mechanism are represented, as the purpose is to show how the movement can be imparted to the first actuating means 4 (for example to the rotating actuating disk 41), using the energy provided by the operating command 85 of the switching apparatus 80, 81.

In practice, the main operating shaft 800 of the switching apparatus 80, 81 can be connected to the rotating actuating disk 41 using at least one connecting rod 801 which runs parallel to the main operating shaft 800 and to its axis of rotation. In this, each rotation of the main operating shaft is transmitted to rotating actuating disk 41, and consequently to the movable contact 3 assembly and to the electrical insulating assembly 5 as previously described. A second connecting rod 802 may be provided to connect the main operating shaft 85 to the “conventional poles” according to known design principles. Other solutions are however possible.

It has been seen that the electrical pole of the present disclosure is remarkably effective in controlling the arcing phenomena, also in presence of short circuit conditions. Although particularly useful and suitable for DC applications, the presently disclosed electrical switching apparatus can be used also for AC applications.

From a manufacturing standpoint, the presently disclosed electrical pole and electrical switching apparatus are relatively easy to manufacture with consequent advantages in terms of costs.

It is therefore clear from the above that the electrical pole of the present disclosure, fully meet the intended aims and purposes. Contingent shapes, materials, and dimensions can be any according to the needs and any variations in this respect shall be considered as part of the present disclosure.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A low or medium voltage electrical pole comprising:
at least one fixed contact and at least one movable contact which can be coupled to or uncoupled from each other between a closed position in which they are in contact with each other and an open position in which they are separated from each other by an opening gap;
a first actuator configured to linearly move the at least one movable contact along a first, longitudinal, axis between the open and closed positions;
an electrical insulating assembly comprising a first barrier element, wherein:
the first barrier element is provided with at least a first insulating wall,
the first barrier elements is rotationally movable around a second, transversal, axis which is perpendicular to the first, longitudinal, axis between a first operative position and a second operative position,
in the first operative position the first insulating wall is positioned on a side of the opening gap, and
when the at least one fixed contact and the at least one movable contact are in the closed position the first barrier element is in the first operative position and when the at least one fixed contact and the at least one movable contact are in the open position the first barrier element is in a second operative position with at least a portion of the first barrier elements interposed between the at least one fixed contact and the at least one movable contact in the opening gap.

2. The electrical pole, according to claim 1, wherein the electrical insulating assembly further comprises a second barrier element, wherein:
the first barrier element comprises at least a first and a second insulating wall separated from each other by an intermediate gap,
the second barrier element is provided with at least a third insulating wall,
the first and second barrier elements are coaxially positioned with respect to each other around the second, transversal, axis,
at least one of the first and second barrier elements is rotationally movable around the second, transversal, axis between a first operative position and a second operative position,
in the first operative position the first and second insulating walls are spaced apart from the insulating wall on opposite sides of the opening gap, and in the second operative position the third insulating wall is at least partially inserted into the intermediate gap between the first and second insulating wall, and
when the at least one fixed contact and the at least one movable contact are in the closed position the first and second barrier element are in the first operative position and when the at least one fixed contact and the at least one movable contact are in the open position the first and second barrier elements are in the second operative position with at least a portion of at least one of said first and second barrier elements interposed between the at least one fixed contact and the at least one movable contact in the opening gap.

3. The electrical pole, according to claim 2, wherein at least one of the first and second barrier elements moves from the first operative position to the second operative position when the at least one movable contact moves from the closed position to the open position, and wherein at least one of the first and second barrier element moves from the second operative position to the first operative position when the at least one movable contact moves from the open position to the closed position.

4. The electrical pole, according to claim 2, further comprising a second actuator configured to move at least one of the first and second barrier elements between the first operative position and the second operative position.

5. The electrical pole, according to claim 4, wherein the second actuator are is operatively connected with the first actuator of the movable contact.

6. The electrical pole, according to claim 1, wherein the first barrier element is rotationally movable around the second, transversal, axis between the first operative position and the second operative position, and wherein a second barrier element is fixed with respect to the fixed contact.

7. The electrical pole, according to claim 2, wherein the first insulating wall is connected to the second insulating wall along a first side parallel to the second, transversal, axis, and forms a slot, parallel to the second, transversal, axis, along a second side opposite to the first side.

8. The electrical pole, according to claim 1, wherein the first actuator of the movable contact comprises a rotating actuating disk and a first kinematic link connecting the rotating actuating disk and the movable contact.

9. The electrical pole, according to claim 8, wherein the rotating actuating disk rotates around a third, transversal, axis substantially parallel to the second, transversal, axis and perpendicular to the first, longitudinal, axis.

10. The electrical pole, according to claim 8, wherein the first kinematic link comprises a lever system configured to transform a rotation movement of the rotating actuating disk to a linear displacement of the movable contact.

11. The electrical pole, according to claim 4, wherein the second actuator comprises a rotating actuating plate operatively connected to the first actuator of the movable contact.

12. The electrical pole, according to claim 9, wherein the rotating actuating plate rotates around the second, transversal, axis and is operatively connected to the rotating actuating disk through a second kinematic link.

13. The electrical pole, according to claim 11, wherein the first barrier element is supported by and rotates with the rotating actuating plate, and wherein the second barrier element is fixed with respect to the fixed contact.

14. A switching apparatus for low or medium voltage applications comprising a first low or medium voltage electrical pole, wherein the electrical pole comprises:
at least one fixed contact and at least one movable contact which can be coupled to or uncoupled from each other between a closed position in which they are in contact with each other and an open position in which they are separated from each other by an opening gap;
a first actuator configured to linearly move the at least one movable contact along a first, longitudinal, axis between the open and closed positions;
an electrical insulating assembly comprising a first barrier element, wherein:
the first barrier element is provided with at least a first insulating wall,
the first barrier element is rotationally movable around a second, transversal, axis which is perpendicular to the first, longitudinal, axis between a first operative position and a second operative position,
in the first operative position the first insulating wall is positioned on a side of the opening gap, and
when the at least one fixed contact and the at least one movable contact are in the closed position the first barrier element is in the first operative position and when the at least one fixed contact and the at least one movable contact are in the open position the first barrier element is in a second operative position with at least a portion of the first barrier element interposed between the at least one fixed contact and the at least one movable contact in the opening gap.

15. The switching apparatus, according to claim 14, further comprising at least one second electrical pole different from the first electrical pole.

16. The switching apparatus according to claim 15, wherein the at least one first electrical pole and the at least one second electrical pole are electrically connected in series.

17. The switching apparatus, according to claim 14, wherein the first electrical pole comprises a further contact pair with a further fixed contact and a further movable contact which can be coupled to or uncoupled from each other between a closed position in which they are in contact with each other and an open position in which they are separated from each other.

18. The switching apparatus, according to claim 17, wherein the further contact pair is connected in series with one of the at least one fixed contact and the at least one movable contact.

19. The switching apparatus according to claim 14, wherein the electrical insulating assembly further comprises a second barrier element, wherein:
the first barrier element is provided with at least a first and a second insulating wall separated from each other by an intermediate gap,
the second barrier element is provided with at least a third insulating wall,
the first and second barrier elements are coaxially positioned with respect to each other around the second, transversal, axis,
at least one of the first and second barrier elements is rotationally movable around the second, transversal, axis between a first operative position and a second operative position,
in the first operative position the first and second insulating walls are spaced apart from the insulating wall on opposite sides of the opening gap, and in the second operative position the third insulating wall is at least partially inserted into the intermediate gap between the first and second insulating wall, and
when the at least one fixed contact and the at least one movable contact are in the closed position the first and second barrier element are in the first operative position and when the at least one fixed contact and the at least one movable contact are in the open position the first and second barrier elements are in the second operative position with at least a portion of at least one of the first and second barrier elements interposed between the at least one fixed contact and the at least one movable contact in the opening gap.

20. The switching apparatus according to claim 19, wherein at least one of the first and second barrier elements moves from the first operative position to the second operative position when the at least one movable contact moves from the closed position to the open position, and wherein at least one of the first and second barrier element moves from the second operative position to the first operative position when the at least one movable contact moves from the open position to the closed position.
